(19) United States
(12) Patent Application Publication
(10) Pub. No.: US 2013/0061571 A1
(43) Pub. Date: Mar. 14, 2013

(54) Laser propelled flight vehicle

(71) Applicant: Robert Van Burdine, Ardmore, TN (US)

(72) Inventor: Robert Van Burdine, Ardmore, TN (US)

(21) Appl. No.: 13/199,992

(22) Filed: Sep. 14, 2011

(51) Int. Cl. F03H 99/00

(52) U.S. Cl. 60/204

(57) ABSTRACT

Disclosed are embodiments for producing thrust, and in particular thrust for the propulsion of a flight vehicle. The embodiments incorporate the on-board laser heating of a propellant to a plasma state for the production of thrust, and of energy being supplied to the on-board laser by remote power sources such as ground based, sea based, space based, or airborne pump lasers.

### REFERENCES CITED

U.S. Patent Documents

| | | |
|---|---|---|
| 4,036,012 | July 1977 | Monsler |
| 5,152,135 | October 1992 | Kare |
| 5,542,247 | August 1996 | Bushman |
| 6,488,233 | December 2002 | Myrabo |
| 6,385,963 | May 2002 | Hunt et. al. |
| 7,080,504 | July 2006 | Pais |

Other References
“Modular Laser Launch Architecture: Analysis and Beam Module Design”, Final Report USRA Subcontract Agreement No. 07605-003-015, 30 Apr. 2004, Revised 18 May 2004 “Ablative Laser Propulsion: An Update, Part I”, AIP Conf. Proc./Volume 702/Issue 1 AIP Conf. Proc. - Mar. 30, 2004 - Volume 702, pp. 166-177
Current U.S. Class 244/171.3, 244/62

### BACKGROUND OF THE INVENTION

Laser propulsion is a form of beam-powered propulsion where the energy source is a remote (usually ground-based) laser system and separate from the reaction mass. This form of propulsion differs from a conventional chemical rocket where both energy and reaction mass come from the propellants carried on board the vehicle. The advantage to this concept is that energy production is not required on board the rocket, so a reaction mass can be selected that provides higher performance.

The concept of laser propelled vehicles was first introduced by Arthur Kantrowitz in 1972. He proposed Ablative Laser Propulsion (ALP), which is a form of beam-powered propulsion in which an external laser is used to burn off a plasma plume from a solid metal propellant, thus producing thrust.

Material is directly removed from a solid or liquid surface at high velocities by laser ablation by a pulsed laser. Depending on the laser flux and pulse duration, the material can be simply heated and evaporated, or converted to plasma.

In U.S. Pat. No. 4,036,012, Monsler teaches a laser powered rocket using a system of optics (mirrors) to concentrate an earth-bound laser beam in the critical zone of the rocket where the beam energy is absorbed by the propellant. A rocket nozzle is provided to expand the hot gas to form a supersonic jet exhaust. This method teaches the direct use of a laser to heat and expand the propellant.

Another laser propulsion method is pulsed plasma propulsion. In U.S. Pat. No. 5,152,135, Kare teaches an apparatus and method for providing thrust using a laser directed to a reflector array providing a controlled region or regions of plasma breakdowns from a laser beam produced at a remotely-based laser source and the carrying of a propellant gas or vapor for continued operation outside the atmosphere. A high energy pulse focused in a gas or on a solid surface surrounded by gas produces breakdown of the gas (usually air). This causes an expanding shock wave which absorbs laser energy at the shock front. Expansion of the hot plasma behind the shock front during and after the pulse transmits momentum to the craft. Pulsed plasma propulsion using air as the working fluid is a form of air-breathing laser propulsion. The Lightcraft, developed by Leik Myrabo of Rensselaer Polytechnic Institute and Frank Mead works on this principle and is described in U.S. Pat. No. 6,488,233.

U.S. Pat. No. 6,385,963, Optical System For Generating Endothermic Fuel For Use In A Propulsion System, Hunt, et al discloses a rocket engine wherein fuel and oxidizer are injected into a thrust chamber and ignited. A laser system is used to heat the fuel to a temperature wherein it dissociates prior to injection into the combustion chamber, thus increasing the energy available to produce thrust. U.S. Pat. No. 5,542,247, Apparatus Powered Using Laser Supplied Energy, Bushman discloses both rocket engine and turbojet engine concepts wherein the laser is used within the combustion chamber for disassociation of the air molecules, producing pressure waves, consequently providing thrust. However, this latter concept does not address the power required to actuate the laser. U.S. Pat. No. 7,080,504, Pais teaches a propulsion system where lasers are used to provide increased thermal activity in the combustion chamber where the propulsion system provides the power for the laser.

Another method of laser propulsion is the Heat Exchanger (HX) Thruster. A laser beam heats a solid heat exchanger, which in turn heats a gas or liquid propellant, converting it to hot gas which is exhausted through a conventional nozzle. Using a large flat heat exchanger allows the laser beam to shine directly on the heat exchanger without focusing optics on the vehicle. The HX thruster has the advantage of working equally well with any laser wavelength and both continuous wave (CW) and pulsed lasers.

Yet another previously disclosed method of laser propulsion is continuous wave plasma propulsion. A continuous laser beam focused in a flowing stream of gas creates a stable laser sustained plasma which heats the gas; the hot gas is then expanded through a conventional nozzle to produce thrust. Because the plasma does not touch the walls of the engine, very high gas temperatures and high specific impulses are possible. Remotely powered CW plasma propulsion has the disadvantage that the laser beam must be precisely focused into the absorption chamber, either through a window or by using a specially-shaped nozzle.

### BRIEF SUMMARY OF THE INVENTION

The present invention relates to a method for propelling a flight vehicle such as a rocket or similar vehicle by heating a propellant for thrust production using laser supplied energy.

The present invention embodies laser propulsion in the form of beam-powered propulsion where the energy source is a remote laser system and separate from the reaction mass. This form of propulsion differs from a conventional chemical rocket where both energy and reaction mass come from the solid or liquid propellants carried on board the vehicle. The advantage to the present invention is that energy production is not required on board the flight vehicle. This provides for safer operation as there are no readily explosive or flammable chemicals on board. It also provides for the high energy thermal expansion of the reaction mass, even to the point of causing the reaction mass to become a plasma. A plasma will have a very high rate of acceleration as it exits the rocket nozzle and can provide a specific impulse in excess of 1000. High thrust can be simultaneously generated as the amount of propellant that can be sufficiently heated is dependent only on the amount of laser pump energy supplied to the flight vehicle.

It is an embodiment of the present invention that the propellant be converted to a plasma state. Plasma is a state of matter similar to gas in which a certain portion of the particles are ionized. In particular the present invention refers to a state of hot plasma. It is notable that all stars are made of plasma.

The method of the present invention is superior to Ablative Laser Propulsion (ALP) as the laser energy supplied to the flight vehicle is collected and applied to the propellant in a highly controlled and optimum manner. Also, the ALP method is best applied in a pulsed mode to allow the previously evaporated material to exit the laser path before the next pulse to avoid scattering of the laser energy. The present invention may operate in any mode, continuous wave, pulsed, etc. . . . as is best for the adsorbing the provided energy and also for the heating of the propellant for the production of thrust.

In U.S. Pat. No. 4,036,012, Monsler teaches a laser powered rocket using a system of optics (mirrors) to concentrate an earth-bound laser beam in the critical zone of the rocket where the beam energy is absorbed by the propellant. A rocket nozzle is provided to expand the hot gas to form a supersonic jet exhaust. This method teaches the direct use of a laser to heat and expand the propellant. The present invention provides for the adsorption of the remote laser beam energy by selected surfaces of the flight vehicle and concentrates the energy utilizing an on-board gain medium integrated into a laser thereby avoiding the aerodynamic and structural issues associated with an optical system of mirrors.

Another laser propulsion method is pulsed plasma propulsion. In U.S. Pat. No. 5,152,135, Kare teaches an apparatus and method for providing thrust using a laser directed to a reflector array providing a controlled region or regions of plasma breakdowns from a laser beam produced at a remotely-based laser source and the carrying of a propellant gas or vapor for continued operation outside the atmosphere. A high energy pulse focused in a gas or on a solid surface surrounded by gas produces breakdown of the gas (usually air). This causes an expanding shock wave which absorbs laser energy at the shock front. Expansion of the hot plasma behind the shock front during and after the pulse transmits momentum to the craft. Pulsed plasma propulsion using air as the working fluid is a form of air-breathing laser propulsion. The Lightcraft, developed by Leik Myrabo of Rensselaer Polytechnic Institute and Frank Mead works on this principle and is described in U.S. Pat. No. 6,488,233. The present invention does not require air as a working fluid and avoids the structural and aerodynamic requirements of a focusing element integrated into the vehicle.

Regarding the several prior disclosures that teach the use of a laser illuminating the combustion chamber to improve the combustion process of a fuel and an oxidizer carried on-board the flight vehicle, the present invention discloses a method for converting the propellant into a plasma state which is the most energetic state possible for a propellant providing thrust and is limited only by the design of the thrust chamber, thus eliminating the need to carry any energy producing fuel and thereby improving the thrust to weight ratio of the flight vehicle.

Another previously disclosed method of laser propulsion is the Heat Exchanger (HX) Thruster. A laser beam heats a solid heat exchanger, which in turn heats a gas or liquid propellant, converting it to hot gas which is exhausted through a conventional nozzle.

Using a large flat heat exchanger allows the laser beam to shine directly on the heat exchanger without focusing optics on the vehicle. The present invention uses the surface of the vehicle to adsorb the laser beamed energy, concentrates that energy in an on-board gain material forming a laser specific to heating the given propellant and heats the propellant to a plasma or near plasma condition without the need of a heat exchanger. In the HX Thruster, the heat exchanger will have to endure some gas pressure and be designed for such loads increasing flight vehicle mass, while the present invention does not generate any gas pressure until the propellant is already injected into the thrust chamber. The present invention can produce a specific impulse of over 1000 while the HX Thruster is usually considered to produce a specific impulse of around 600.

The present invention is superior to the previously disclosed concepts of continuous wave (CW) plasma propulsion. The previous concepts require that a CW laser beam be focused in a flowing stream of gas creating a stable laser sustained plasma which heats the gas; the hot gas is then expanded through a conventional nozzle to produce thrust. Remotely powered CW plasma propulsion has the disadvantage that the laser beam must be precisely focused into the absorption chamber, either through a window or by using a specially-shaped nozzle. The present invention uses the surface of the flight vehicle to collect the remotely supplied energy and concentrates that energy onto the propellant with an on-board laser converting the propellant into a plasma. The present invention greatly reduces the beam focusing and tracking requirements and requires only that enough energy intersect the flight vehicle to provide the required energy.

It is an embodiment of the present invention to provide a propulsion system wherein laser energy is used to provide thermal activity in a propellant thereby generating thrust.

It is a further embodiment of the present invention to provide a propulsion system wherein laser energy is used to provide thermal activity to a propellant wherein the power for the laser is provided by an external source.

It is an object of the present invention to provide propulsive power to a flight vehicle by illumination of a laser on-board the flight vehicle by remote lasers, and the on-board laser adsorbing and re-emitting this power to heat an expansion material to provide thrust. It is a preferred embodiment of the present invention that the expansion material be heated by the on-board laser to the extent that the expansion material is converted to a plasma state.

### BRIEF DESCRIPTION OF THE SEVERAL VIEWS OF THE DRAWINGS

The present invention will now be described more fully hereinafter with reference to the accompanying figures, in which embodiments of the invention are shown. This invention may, however, be embodied in many different forms and should not be construed as limited to the embodiments set forth herein.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terms “laser” and “lasers” refer interchangeable to a single laser comprised of a single gain medium and associated components or a plurality of gain mediums and associated components, the interchangeability relating to the convergence of the developed laser beam power upon the propellant in all cases. The term “gain medium” refers to any material that has gain resulting from the stimulated emission of electronic or molecular transitions to a lower energy state from a higher energy state previously populated by a pump source. The term “flight vehicle” relates to any vehicle intended to sustain itself above the Earth's or other planetary surface and includes but is not limited to rockets, aircraft, propelled balloons and other such constructions or assemblies.

The present invention is particularly suitable for receiving optical energy in the form of a beam or beams, collecting and concentrating that energy through the use of a laser gain medium, and emitting the concentrated energy to vaporize a propellant for the production of thrust.

The present invention is particularly suitable for the production of thrust through the generation of a superheated plasma

The embodiments of the invention will be better understood from the following summary description with reference to the drawings, which are not necessarily drawn to scale and in which:

FIG. 1 is a diagram illustrating embodiments of the present invention including remote energy being supplied to an on-board gain medium that concentrates and directs the energy to heat the on-board propellant mass with associated gain medium cooling;

FIG. 2 is a diagram illustrating embodiments of the present invention including remote energy being supplied to an on-board gain medium that concentrates and directs the energy to heat the on-board propellant mass with associated gain medium cooling resulting from the direct flow of the propellant through the gain medium mass;

FIG. 3 is a diagram illustrating embodiments of the present invention including remote energy being supplied to an on-board gain medium comprising the surface or surfaces of the flight vehicle. The gain medium forms a laser beam that pumps an on-board laser that that concentrates and directs the energy to heat the on-board propellant mass. Alternately the gain mediums comprising the flight vehicle surface are directly emitted into the thrust chamber to directly heat the propellant;

FIG. 4 is a cross-sectional view showing a reflective structure causing multiple passes of the remote pump beam through the gain medium of the present invention;

FIG. 5 is a cross-section view showing the configuration of the on-board laser, the propellant flow, and the thrust chamber.

FIG. 6 is a diagram of some of the possible configurations and relative locations of the remote pump beam and its intersecting of the flight vehicle, and in particular the gain medium of the on-board laser;

FIG. 7 is a diagram of some of the possible configurations and relative locations of the remote pump beam and its intersecting of the flight vehicle, and in particular the gain medium of the flight vehicle surface lasers;

FIG. 8 is a cross-section diagram illustrating possible variations of the flight vehicle body cross sections.

### DETAILED DESCRIPTION OF THE INVENTION

The embodiments of the invention and the various features and advantageous details thereof are explained more fully with reference to the non-limiting embodiments that are illustrated in the accompanying drawings and detailed in the following description.

It should be understood that the corresponding structures, materials, acts, and equivalents of all means or step plus function elements in the claims below are intended to include any structure, material, or act for performing the function in combination with other claimed elements as specifically claimed. Additionally, it should be understood that the above-description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. Well-known devices and processing techniques are omitted in the above-description so as to not unnecessarily obscure the embodiments of the invention.

Finally, it should also be understood that the terminology used in the above-description is for the purpose of describing particular embodiments only and is not intended to be limiting of the invention. For example, as used herein, the singular forms “a”, “an” and “the” are intended to include the plural forms as well, unless the context clearly indicates otherwise. Furthermore, as used herein, the terms “comprises”, “comprising,” and/or “incorporating” when used in this specification, specify the presence of stated features, integers, steps, operations, elements, and/or devices, but do not preclude the presence or addition of one or more other features, integers, steps, operations, elements, devices, and/or groups thereof.

The embodiments of the invention will be better understood from the following detailed description with reference to the drawings, which are not necessarily drawn to scale and in which:

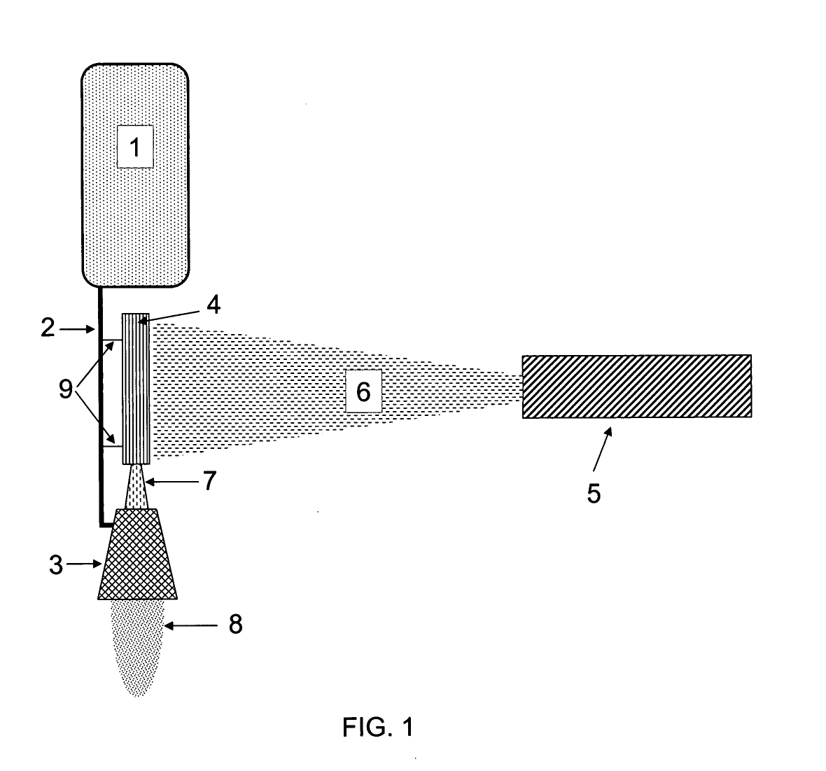

FIG. 1 is a diagram illustrating embodiments of the present invention including on-board propellant 1. Propellant 1 is transferred to thrust chamber 3 via propellant conveyance 2; vehicle laser 4 develops vehicle laser beam 7; vehicle laser beam 7 enters thrust chamber 3 and vaporizes propellant 1 to produce thrust 8; remote pump laser 5 producing pump laser beam 6; pump laser beam 6 intersecting the gain medium of vehicle laser 4 causing vehicle laser 4 to produce vehicle laser beam 7. Vehicle laser beam 7 enters the thrust chamber 3 and heats the propellant 1 to produce thrust 8. Thrust 8 is preferred to be a plasma as a hot plasma would produce the highest acceleration of the propellant and therefore the highest specific impulse. Vehicle laser 4 is cooled by propellant 1 through gain medium coolant supply 9.

Propellant 1 may be any solid liquid or gas, or combination thereof, suitable for heating by vehicle laser beam 7 for the production of thrust 8. If a liquid propellant 1 may be but not limited to a cryogenically condensed gas such as hydrogen, nitrogen, helium, or such gas as desirable, or it may be a room temperature or compressed liquid such as water or liquid methane, or a room temperature or thermally liquefied metal such as mercury or lead. If a solid propellant 1 may be but not limited to slush hydrogen, frozen nitrogen, solidified carbon dioxide, powered high explosive such as Composition C or any of the family of related plastic explosives consisting primarily of RDX. Solids for propellant 1 may also include but is not limited to plastics, hydrocarbons, powdered metals, powdered non-metals, water ice, and combinations thereof. If a gas propellant 1 may be but not limited to atmospheric air, any compressible gas, any gas suitable for the production of a plasma including the noble gasses, or any organic gas disassociateable to a plasma.

Thrust 8 is the result of the heated propellant 1 by vehicle laser beam 7. Thrust 8 is preferred to be produced by the transformation of propellant 1 into a plasma, which is a superheated and ionized form of matter.

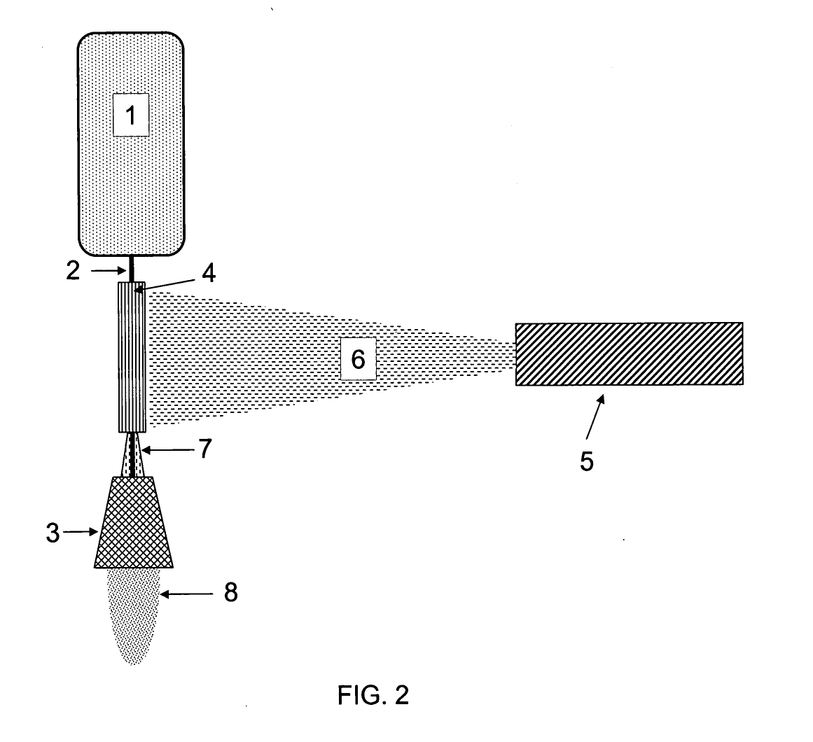

FIG. 2 is a diagram illustrating embodiments of the present invention including on-board propellant 1. Propellant 1 is transferred to thrust chamber 3 via propellant conveyance 2; vehicle laser 4 develops vehicle laser beam 7; vehicle laser beam 7 enters thrust chamber 3 and vaporizes propellant 1 to produce thrust 8; remote pump laser 5 producing pump laser beam 6; pump laser beam 6 intersecting the gain medium of vehicle laser 4 causing vehicle laser 4 to produce vehicle laser beam 7. Vehicle laser beam 7 enters the thrust chamber 3 and heats the propellant 1 to produce thrust 8. Thrust 8 is preferred to be a plasma as a hot plasma would produce the highest acceleration of the propellant and therefore the highest specific impulse. Vehicle laser 4 is cooled by propellant 1 through direct contact with propellant conveyance 2. Propellant conveyance 2 passes through the center of vehicle laser beam 7 which is configured to not intersect propellant conveyance 2.

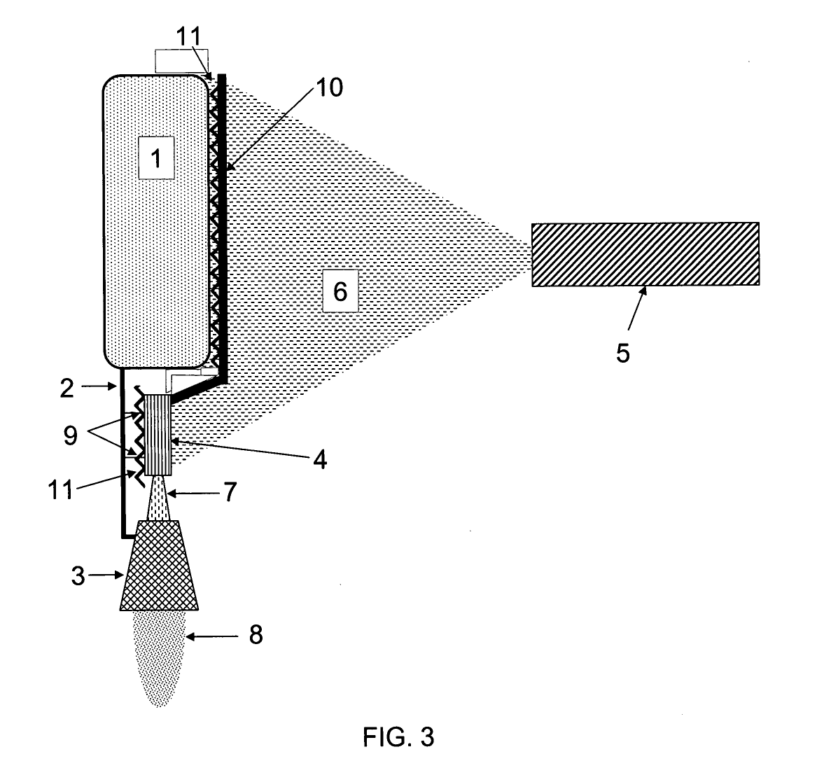

FIG. 3 is a diagram illustrating embodiments of the present invention including pump laser beam 6 being supplied by remote pump laser 5 to an on-board vehicle surface gain medium 10 comprising the surface or surfaces of the flight vehicle. The vehicle surface gain medium 10 forms a laser beam that pumps vehicle laser 4 that that concentrates and directs the energy to heat the propellant 1 mass. Alternately the vehicle surface gain medium 10 comprising the flight vehicle surface are directly emitted into the thrust chamber 3 to directly heat the propellant 1. Reflectors 11 reflect any of pump laser beam 6 back through the vehicle surface gain medium 10 and the vehicle laser 4 that is not captured on the first pass through. Propellant 1 is transferred to thrust chamber 3 via propellant conveyance 2; vehicle laser 4 develops vehicle laser beam 7; vehicle laser beam 7 enters thrust chamber 3 and vaporizes propellant 1 to produce thrust 8; remote pump laser 5 producing pump laser beam 6; pump laser beam 6 intersecting the gain medium of vehicle laser 4 causing vehicle laser 4 to produce vehicle laser beam 7. Vehicle laser beam 7 enters the thrust chamber 3 and heats the propellant 1 to produce thrust 8. Thrust 8 is preferred to be a plasma as a hot plasma would produce the highest acceleration of the propellant and therefore the highest specific impulse. Vehicle laser 4 is cooled by propellant 1 through gain medium coolant supply 9.

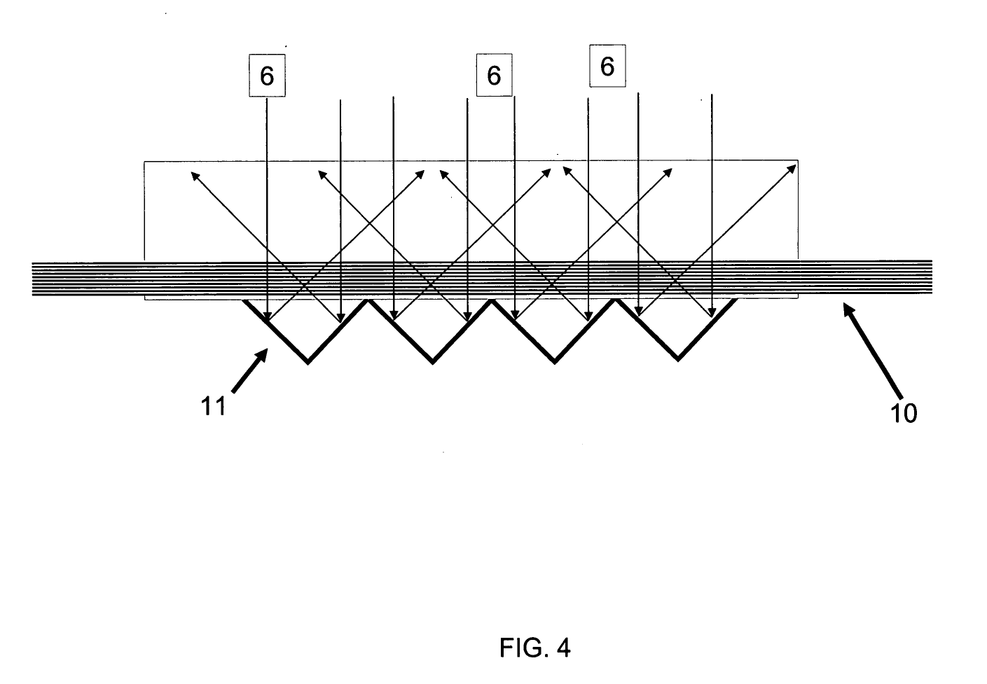

FIG. 4 is a cross-sectional view showing reflectors 11 causing multiple passes of the pump laser beam 6 through the vehicle surface gain medium 10 of the present invention;

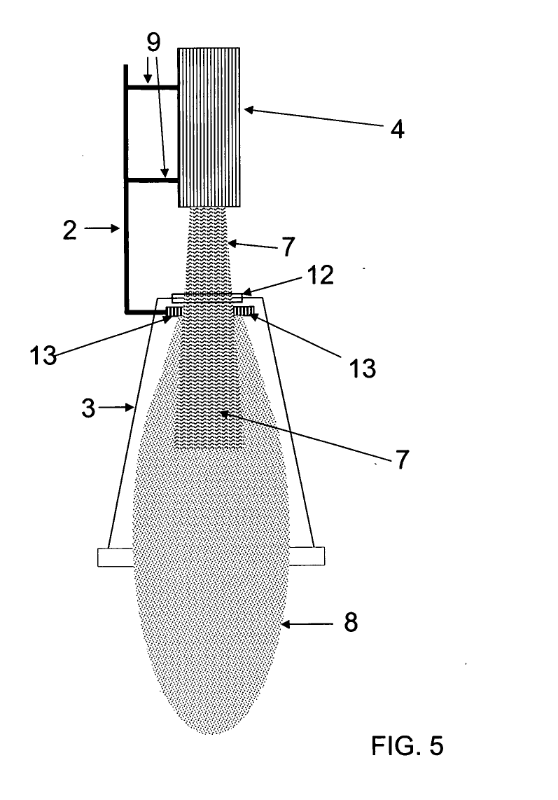

FIG. 5 is a cross-sectional view illustrating propellant 1 being transferred to thrust chamber 3 via propellant conveyance 2; propellant conveyance 2 injects propellant 1 into propellant diffuser 13 which separates and diffuses the propellant 1 for intersection by vehicle laser beam 7; laser beam 7 enters thrust chamber 3 through laser entrance hole window 12; vehicle laser 4 develops vehicle laser beam 7; vehicle laser beam 7 enters thrust chamber 3 and vaporizes propellant 1 to produce thrust 8; remote pump laser 5 producing pump laser beam 6; pump laser beam 6 intersecting the gain medium of vehicle laser 4 causing vehicle laser 4 to produce vehicle laser beam 7. Vehicle laser beam 7 enters the thrust chamber 3 and heats the propellant 1 to produce thrust 8. Vehicle laser 4 is cooled by propellant 1 through gain medium coolant supply 9.

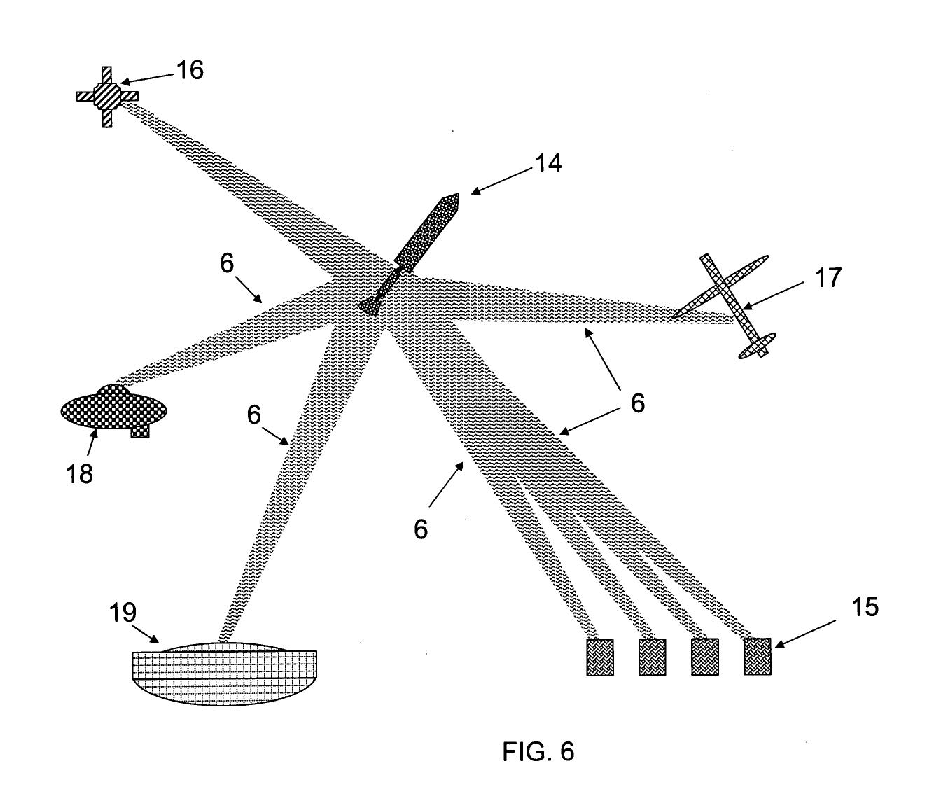

FIG. 6 is a diagram of some of the possible configurations and relative locations of the remote pump lasers 5, their pump laser beams 6 and their intersecting of the flight vehicle 14, and in particular the gain mediums of the vehicle laser 4. Ground based remote pump lasers 15 are shown as a complex of lasers. All remote pump lasers may be a single or plurality of lasers and associated pump laser beams 6. Airborne remote pump lasers 17, sea based remote pump lasers 19, atmosphere bases remote pump lasers 18, and space based remote pump lasers 17 are illustrated illuminating flight vehicle 14 and in particular the gain mediums of the vehicle laser 4.

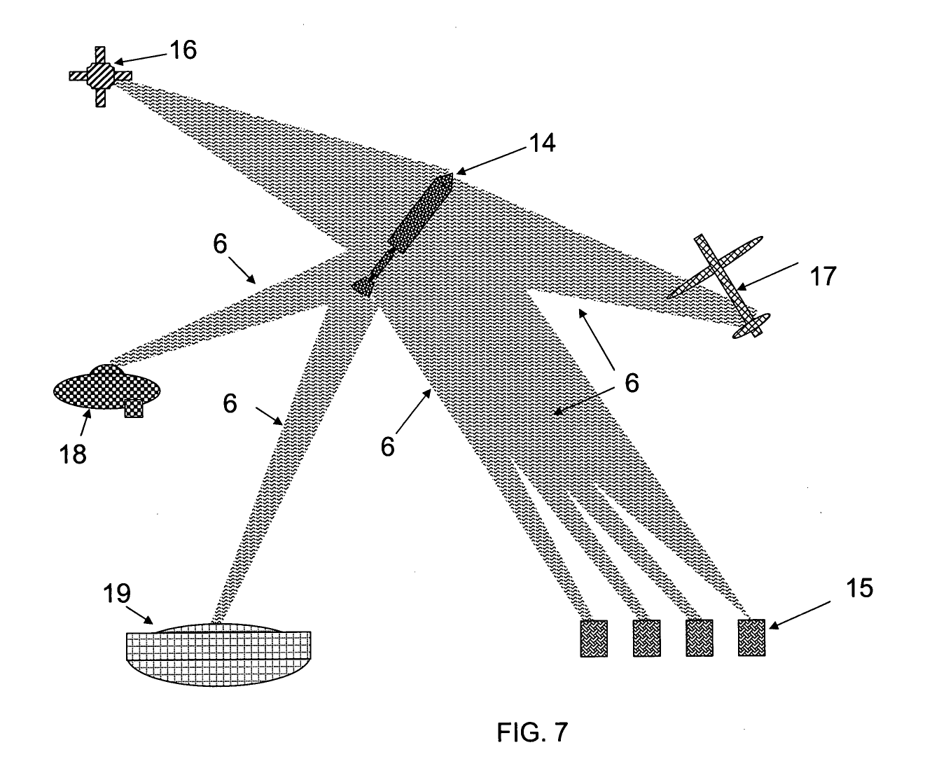

FIG. 7 is a diagram of some of the possible configurations and relative locations of the remote pump lasers 5, their pump laser beams 6 and their intersecting of the flight vehicle 14, and in particular the gain mediums of the vehicle laser 4 and the vehicle surface gain mediums 10. Ground based remote pump lasers 15 are shown as a complex of lasers. All remote pump lasers may be a single or plurality of lasers and associated pump laser beams 6. Airborne remote pump lasers 17, sea based remote pump lasers 19, atmosphere bases remote pump lasers 18, and space based remote pump lasers 17 are illustrated illuminating flight vehicle 14 and in particular the gain mediums of the vehicle laser 4 and the vehicle surface gain mediums 10.

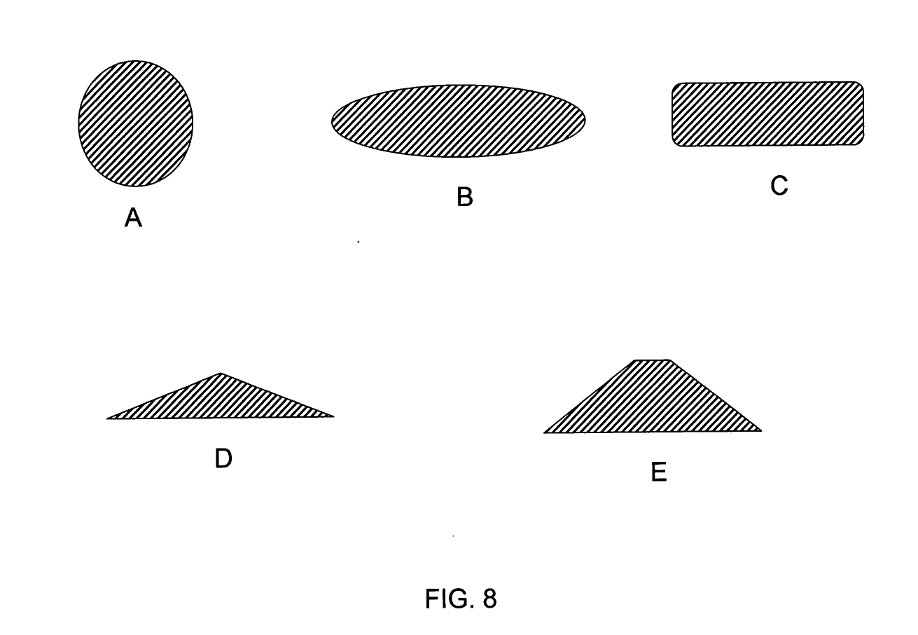

FIG. 8 is a cross-section diagram illustrating possible variations of the flight vehicle 14 body cross sections.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method wherein an on-board laser generates a laser beam, said beam intersects and illuminates a propellant material, said propellant material is heated by energy from the laser beam, said propellant material being comprised singularly or simultaneously of solids, liquids or gasses, said laser and material being incorporated into the body of a flight vehicle, said propellant material being thermally excited, said thermally excited propellant material being directed out of the flight vehicle for the production of thrust, said on-board laser being supplied with radiated energy from an external source, said external source being a remote laser or lasers emitting a pump beam or beams, said pump beam or beams intersecting the on-board laser or lasers, said remote laser or lasers being based on the ground, on the sea, on an airborne platform or in space, said flight vehicle being propelled by said thrust.

2. A method wherein a remote laser or lasers emitting a pump beam or beams intersect with surfaces of a flight vehicle, said surfaces containing flight vehicle laser gain mediums, said flight vehicle laser producing a laser beam or beams on board the flight vehicle that passes through a laser hole window into a thrust chamber heating a propellant to the plasma state, said plasma expelling from the thrust chamber producing propulsive thrust.

3. A method wherein remote lasers provide pump energy to a plurality of lasers mounted on a flight vehicle, said flight vehicle lasers generating beams that further pump a single flight vehicle laser that generates a laser beam that heats a propellant for the production of thrust.
